(19) United States
(12) Patent Application Publication
(10) Pub. No.: US 2022/0335450 A1
(43) Pub. Date: Oct. 20, 2022

(54) SYSTEM AND METHOD FOR PRIVACY-PRESERVING ANALYTICS ON DISPARATE DATA SETS

(71) Applicant: TRUATA LIMITED, DUBLIN (IE)

(72) Inventors: Michael Fenton, GREYSTONES (IE); David Fagan, DUBLIN (IE); Maurice Coyle, DUBLIN (IE); Noel Rogers, DUBLIN (IE); Imran Khan, DUBLIN (IE); Aydin Ulas, DUBLIN (IE)

(73) Assignee: TRUATA LIMITED, DUBLIN (IE)

(21) Appl. No.: 17/716,399

(22) Filed: Apr. 8, 2022

Related U.S. Application Data
(60) Provisional application No. 63/172,929, filed on Apr. 9, 2021.

(51) Int. Cl. G06Q 30/02; G06F 16/22; G06F 16/2455; G06K 9/62

(52) U.S. Cl. CPC G06Q 30/0201; G06F 16/2237; G06F 16/24556; G06K 9/6256

(57) ABSTRACT

A system and method for providing the ability to use k-anonymous groups to analyze disparate data sets via the use of either individual to segment or segment to segment matching using modelling or querying approaches are disclosed. The system and method include creating a common representation across all consumer and producer data sets, training one or more models or defining one or more queries optimized to recognize the behavior of the specified subjects within the generated common representation, evaluating those models or executing those queries on the common representation of the producer data set(s) to identify likely candidates for the specified input data subjects in each producer data set, the performing of actions over the identified subjects for each producer data set, and output the analytics result.

### CROSS-REFERENCE TO RELATED APPLICATIONS

This application claims the benefit of U.S. Provisional Application No.

63/172,929 filed Apr. 9, 2022, which is incorporated by reference as if fully set forth.

### FIELD OF INVENTION

The present system and method include elements for privacy preserving analytics of disparate data sets.

### BACKGROUND

A common problem in the modern privacy-conscious data landscape is that businesses need to be able to perform analytics over data sets from different sources. The different sources may have different legal constraints and backgrounds. Examples may include running analytics over a combination of consented and non-consented data, or the joining or merging of data sets from different companies or subsidiaries.

A common approach is to merge or join the data sets in question deterministically, if possible (such as joining or merging on common values or keys). Such a deterministic combination may be performed using any number of unique identifiers common to each data set, such as an email address, phone number, or system-generated ID. Where no common unique identifier (or set of identifiers) exists between data sets, matching may be performed using combinations of fields, or quasi-identifiers, common across the data sets. While this often constitutes a probabilistic form of matching, very high-precision matching can frequently be performed where data sets contain many records and columns. These traditional forms of data combination and matching techniques seek to link individuals across data sets. However, with the advent of strict data protection regulations, these types of matching are prohibited without the consent of the individuals for the use of their data in each data set and for each defined analytical purpose.

### SUMMARY

A system and method, which in certain configurations are implemented via a computer, for providing the ability to use k-anonymous groups to analyze disparate data sets via the use of either individual to segment or segment to segment matching using data modeling or querying are disclosed. The system and method may include a sub-system for automated feature generation to create a common representation across one or more producer and consumer data sets, a describer sub-system that includes training one or more models or executing one or more queries optimized to recognize the behavior of the specified subjects within the common representation for the consumer data sets, a finder sub-system that highlights likely candidates for the specified subjects across the common representations of the one or more producer data sets, the performing actions for each producer data set, and output the analytics result.

The automating may include evaluating an input list, creating a detailed feature array, forming geo-spatial features, forming temporal features, forming features based on spending or other behaviors, and forming features based on product, brand or other affinities.

The performing may include creating a detailed feature array, evaluating a classifier, compiling vectors, sorting and grouping the array, and performing analytics.

The training or executing may occur via a describer and the performing actions may occur via a finder.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates a system that provides the ability to use k-anonymous groups/segments to perform combined analytics over disparate data sets via the use of either individual-to-segment or segment-to-segment matching using modelling or querying approaches;

FIG. 2 illustrates a method that provides the ability to use k-anonymous groups/segments to analyze disparate data sets via the use of either individual-to-segment or segment-to-segment matching using modelling or querying approaches;

FIG. 3 illustrates an automated feature generation sub-system to create a common representation;

FIG. 4 illustrates an exemplary configuration where groups of people are included within the data of a first party (i.e., the consumer), and the first party desires to acquire (i.e., consume) analytics about the groups of people from data sets of at least one other party's data (i.e., from the producers of analytics);

FIG. 5 illustrates an exemplary configuration where the first party (i.e., the consumer) desires to utilize analytics from data sets of at least one other party's data (i.e., the producer) to aid in grouping and then analyzing the data of the first party (i.e., the consumer); and

FIG. 6 illustrates an exemplary configuration combining the configurations of FIG. 4 and FIG. 5.

### DETAILED DESCRIPTION

Where legal or regulatory restrictions prevent deterministic data combination, or even analytics over the same group of identified individuals over disparate data sets, or where data controllers require their data sets to remain within their own environments or multiple data controllers wish to restrict or prevent access to each other's' data sets, a technique for performing analytics over multiple disparate data sets that does not require merging or joining of the data sets and involves keeping and analyzing the data sets separately while preventing individual re-identification allows for privacy-preserving and compliant insights to be extracted therefrom.

A system and method for providing the ability to use k-anonymous groups to analyze disparate data sets via the use of either individual to segment or segment to segment matching using modelling approaches are disclosed. The system and method may include a sub-system for automated feature generation to create a common representation across one or more consumer and producer data sets, a describer sub-system that includes training one or more models or executing one or more queries optimized to recognize the behavior of the specified subjects within the generated common representation for the consumer data sets, a finder sub-system that highlights likely candidates for the specified subjects across the common representations of the one or more producer data sets, the performing of analytics for each producer data set, and output the analytics result.

A consumer is a party who is the eventual recipient of the outputs/analytics/insights that are derived from the processes defined herein. There may be one or multiple consumers, each with any number of datasets. Consumer datasets are capable of supporting the generation of the Common Representation (depending on the available data features present in the producer dataset(s)), and may or may not be involved in the analytical aspects of the process.

A producer is a party who is responsible for the production of outputs/analytics/insights which are to be consumed/delivered to/received by the consumer(s). There may be one or multiple producers, each with any number of datasets. Producer datasets are capable of supporting the generation of the Common Representation (depending on the available data features present in the Consumer dataset(s)), and are by definition involved in the analytical aspects of the overall process.

The present system and method use modelling or querying approaches to learn and/or recognize or identify similarly behaving segments across multiple data sets. This allows the processing of data sets that may contain the data of the same or similarly behaving individuals but which may have been collected for different purposes in a compliant way such that analytics can be performed across the two or more data sets and deliver increased value and insight.

The present system and method overcome problems and issues created by legal/regulatory barriers, namely that regulations such as the GDPR that prohibit the one-to-one matching of individuals across data sets collected for different purposes or by different controllers without the explicit consent of the data subjects for such matching to occur. The present system and method also overcome issues where different data controllers may want to limit access to their data and prevent other controllers from accessing or analyzing their data in ways which they do not fully support or authorize. This permits the performing of analyses of behavior across different data sets to maintain and increase the value of data within a modern organization while remaining compliant with data protection regulations as a means of finding an alternative to one-to-one matching.

By abstracting away from the data to shared features in a “common representation,” the present system and method build a probabilistic matching approach that overcomes the relevant issues that prevent a deterministic data combination approach in which data sets are merged or joined. The system and method focus on highlighting related sub-sets of all data sets involved at a grouped/segmented level, which in one embodiment may enable the enriching of the consumer data set(s) with aggregated information from the producer data set(s) so that the resulting enriched data set has broader analytical utility, without containing any additional re-identification risk or compromising the fundamental right to privacy of the data subjects associated with either consumer or producer(s), or compromising the need for confidentiality of the controllers of producer or consumer data set(s).

The system and method allow for the combined analysis of disparate data sets to produce enriched analytics that are fully compliant with data protection regulations.

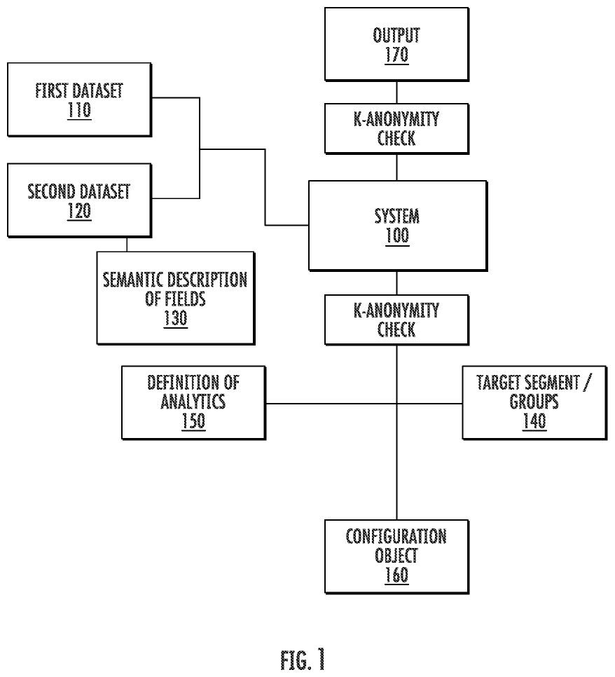

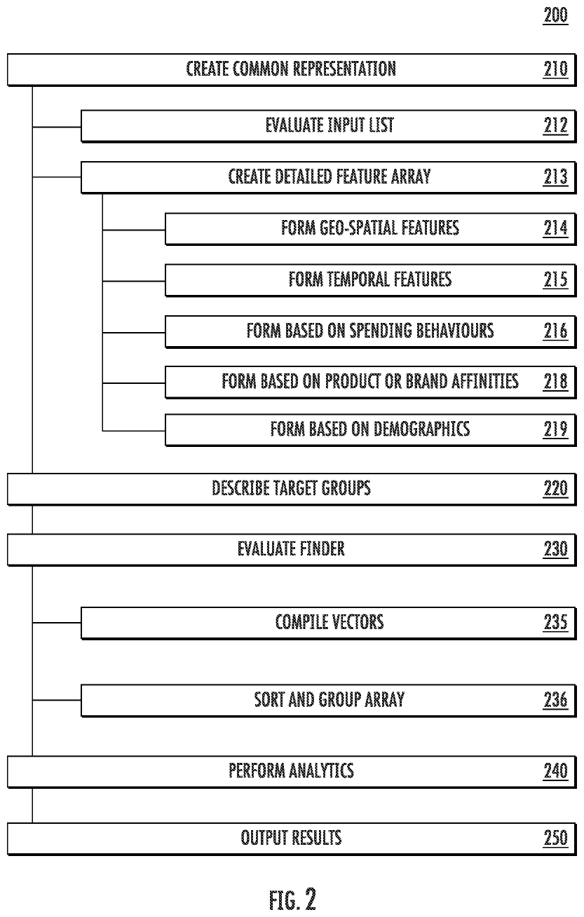

Referring to FIGS. 1 and 2, the system 100 and method 200 provide the ability to use k-anonymous features to highlight behaviorally similar groups/segments across disparate data sets via the use of either individual-to-segment or segment-to-segment matching using modelling or querying approaches.

In FIG. 1, the system 100 uses inputs including a consumer (i.e., first) data set 110, one or more producer (i.e., second) data sets 120, a list of overlapping fields across consumer and producer data sets, with semantic descriptions of each field 130, a list of S segments/groups, where each segment s belonging to S defines a set of k subjects from the target segment/groups (consumer data set) 140, a definition of analytics 150 to be performed across the consumer data sets 110 and one or more producer data sets 120, and a configuration object 160. For the list of S segments/groups, where each segment s belongs to S group defines a set of k subjects from the consumer data set, in one embodiment a subject may be a data subject or identified individual, and in another embodiment a subject may be an arbitrary object such as a product, process or other entity. The output 170 of FIG. 1 is described with respect to FIG. 2 below.

With the above inputs, the system 100 and method 200 in FIG. 2 may include at step 210 creating a common representation, such as by automated feature generation, at step 220 describing one or more target groups, such as by training one or more models or execute one or more queries optimized to recognize the behavior of the specified subjects within the generated common representation of the consumer data, evaluate the finder at step 230 by executing the queries on the producer data set(s) to identify likely candidates for the specified input data subjects in each producer data set, perform analytics over the identified subjects for each producer data set at step 240, and output the analytics results at step 250.

The training of models or execution of queries at step 220 may be performed through different methods, such as (but not limited to): machine learning classification; deterministic algorithm; neural network; auto-encoder; federated learning; execution of data set queries; or human decision making.

In order to jointly analyze two or more data sets, there needs to be overlapping fields or behaviors between the data sets. These overlapping fields or behaviors may be used to describe each data set in a common way in order to match the data sets.

In the creating a common representation at step 210, the system 100 may evaluate an input list of overlapping fields and semantic descriptions to ascertain the most appropriate features to generate at step 212. The system 100 may create a detailed feature array from the provided list of overlapping features at step 213. This feature array may be expanded and augmented to utilize any view on the data as configured. This common representation is built for all given consumer and producer data sets alike in step 210.

In an embodiment, features may take the form of geo-spatial features where location-based fields are provided at step 214. For example, one data set may include households, and another data set may include purchase transactions. The common representation for both data sets may include a geo-spatial view on each data set.

In an embodiment, features may take the form of temporal features where temporal (e.g. date/time) fields are provided at step 215. For example, one data set may include faults, and another data set may include weather events. The common representation for both data sets may include a temporal view of both data sets.

In an embodiment, features may be based on spending behaviors such as recency, frequency and monetary spend at step 216. For example, one data set may include loyalty programs, and another data set may include bank transactions. The common representation for both data sets may include a transactional view of both data sets using products, merchants, amounts, or the like.

In an embodiment, features may be based on product, brand or other affinities at step 218.

In an embodiment, features may be based on demographics or other data subject characteristics common to both data sets at step 219.

Combinations of the respective forms may also be utilized in creating a detailed feature array in step 213. For example, one or more of geo-spatial features 214, temporal features 215, spending behaviors 216, product or brand affinities 218 and demographics 219 may be utilized. Each of the respective categories may be represented or not and may be weighted more heavily than others in the creation of the feature array.

The data is used to identify the related segments/groupings of data subjects on both sides as will be described further herein. Analytics may be performed on those segments/groupings in the knowledge that the analytics are effectively linked (i.e. the analytics or insights over an identified group on one data set may be applied to the same identified group on the other data set). The system identifies a behaviorally similar segment/group of people on both sides by sharing the trained model or queries between the consumer and all subsequent producers.

In performing actions for each producer data set at step 230, the system 100, for each producer data set, may evaluate the trained model(s) or execute queries over the common representation/detailed feature array (as generated in step 210) to produce a vector of probabilities for each segment, compile S probability vectors into an S-dimensional probability array at step 235, sort and group the S-dimensional probability array to identify the most likely subjects in the producer data set for each segment s belongs to S at step 236, and may perform the specified analytics over the grouped/segmented producer data set.

The describer is a modelling process, which may be an encoder, for example. The describer may input a group of candidates from the consumer data set and describe this group in terms of the common representation extracted in the previous step. The description is done via a modelling or querying process. In one embodiment, this description may be represented as a logistic regression model. In another embodiment, the description may represent a neural network. In another embodiment, the description may represent a set of queries over the common representation. The describer may take a defined group of data subjects from one data set and build a model or define a set of queries that describes those data subjects based on the common representation.

The finder is a modelling or querying process, which may be a decoder, for example. The model or queries may be provided to the finder. The finder may apply the model or execute the queries to the common representation of the producer data set(s). The output is a group of candidates that best match the model or query results generated in the describer. This output allows access to the raw data in the producer data set(s) related to this group and perform analytics on said raw data. The finder takes the built model or defined queries from the describer and applies the model or executes the queries over the common representation from a different or another data set in order to find the data subjects that match those from the input segment/group.

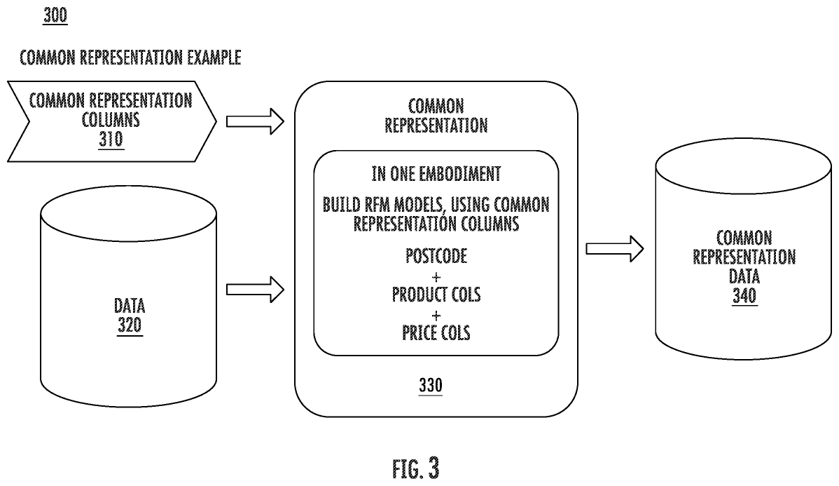

Automated feature generation sub-system to create a common representation in step 210 is further depicted in FIG. 3. The input identified as “Common Representation Columns” 310 is the semantic description of step 212 described above. The common representation 330 is augmenting the input data and creating the common representation data 340 in step 213 and 230 and step 214, 215, 216, 218, 219 described above.

In one embodiment, an RFM process may be used. The RFM process may use common data fields, such as postcode plus product columns plus price columns. As would be understood by those possessing an ordinary skill in the pertinent arts, RFM is a method used for analyzing customer value. RFM may be used for database marketing and direct marketing and has received particular attention in retail and professional services industries. RFM stands for the three dimensions: recency (How recently did the customer purchase?), frequency (How often does the customer purchase?), and monetary value or magnitude (How much does the customer spend or how many units does the customer use or consume?).

When RFM or a similar process is used, a score is assigned for each dimension on a scale from 1 to 10 to create 10 distinct categories. The maximum score represents the preferred behavior and a formula may be used to calculate the three recency, frequency, and monetary scores for each customer.

Alternatively, categories may be defined for each attribute. For instance, if RFM is the select common representation, recency may be broken into three categories: customers with purchases within the last 90 days; between 91 and 365 days; and longer than 365 days. Such categories may be derived from business rules, domain knowledge, industry standards or using data mining techniques to find meaningful breaks.

Once each of the attributes has appropriate categories defined, features are created from the intersection of the values. If there were three categories for each attribute, then the resulting matrix may have twenty-seven possible combinations. Companies may also decide to collapse certain sub-features, if the gradations appear too small to be useful. The resulting features may be ordered from most valuable (highest recency, frequency, and value) to least valuable (lowest recency, frequency, and value).

In other implementations techniques different from RFM may be used. Such variations may include RFD (recency, frequency, duration), RFE (recency, frequency, engagement), RFM-I (recency, frequency, monetary value-interactions), and RFMTC (recency, frequency, monetary value, time, churn rate), for example. Any segmentation technique that can be applied to both data sets may be used. The outputs of these automated feature generation techniques constitute the Common Representation, upon which the describing target groups 220 or evaluating finder 230 may be trained or evaluated based on the values for any fields or behaviors that capture the nature of the overlap or other analytical relationship between the one or more data sets.

In other implementations, the data that comprises the common representation may be provided or sourced from a third party, to enable combined analytics involving producer data sets and consumer data sets that do not share commonalities. While third party data may be used in many situations, third party data may be used in situations where the producer and consumer data sets fail to share any common features. In this scenario, the producer and consumer may use third part data to enrich their own data. After involving the third-party data, features in common may be derived from this enriched provider data to build the common representation.

The finder may score each data subject for membership in a given input group using the common representation. When multiple input groups are involved, the finder may score each data subject for membership in each group using the common representation. The scoring may be performed for example by determining the correlation of the data subject's attributes with the values/categories in each input group. The scoring may be performed in any number of ways. In one embodiment, the scoring may represent a probability, in another embodiment the scoring may be a binary flag, or most votes based on an ensemble modelling. As illustrated in Table 1, the score for each data subject (DS) in each group may be itemized, comprising an exemplary embodiment of step 235.

TABLE 1

| Data Subject | Group 1 | Group 2 | . . . | Group N |
|---|---|---|---|---|
| DS 1 | 0.245 | 0.485 | . . . | 0.988 |
| DS 2 | 0.055 | 0.884 | . . . | 0.360 |
| DS 3 | 0.879 | 0.025 | . . . | 0.277 |
| DS 4 | 0.966 | 0.138 | . . . | 0.003 |
| DS 5 | 0.677 | 0.320 | . . . | 0.428 |

The scoring of each data subject for membership in each group/segment enables the system and method to perform analytics over any combination of non-overlapping (i.e., one group per data subject) or overlapping (i.e., multiple groups per data subject) groups/segments for combined analytics (step 236).

For example, for non-overlapping groups where each subject belongs to only one group with groups being or not being of a defined size. As illustrated in Table 2, data subjects may belong to a single group.

In another example, for overlapping groups, each data subject may belong to multiple groups where the groups being or not being of a defined size. As illustrated in Table 3, data subjects may belong to multiple groups.

Table 2 and Table 3 illustrate exemplary outputs of the finder (steps 235 and 236), for example.

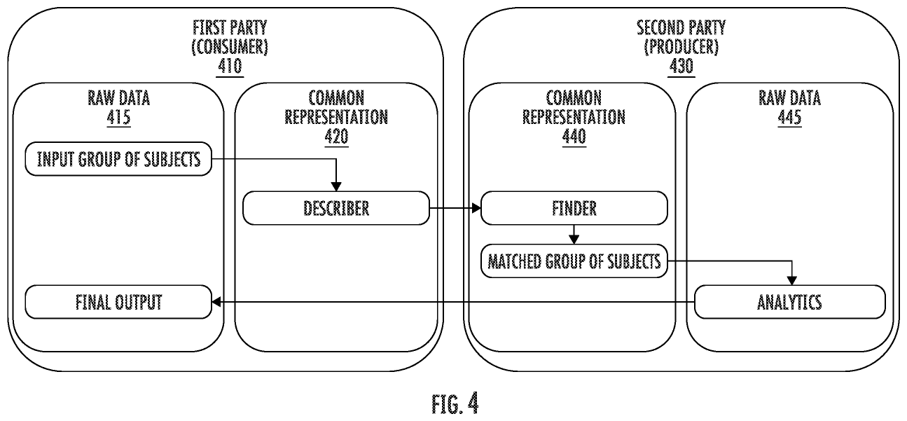

FIG. 4 illustrates an exemplary configuration where groups of people are identified within the data of a first party 410 (i.e., the consumer), and the first party desires to acquire (consume) analytics about the same groups of people from data sets of at least one other party's 430 data (i.e., the producer). First party 410 may include raw data 415 having an input of a group of subjects. Using the common representation 420, the initial group of subjects in raw data 415 is provided as input to the describer, which then trains a model or defines a set of queries to recognize those subjects as distinct from all other subjects.

Using the common representation 440 of second party 430 (i.e., the producer), the finder may apply the model or execute the queries provided by the describer of the common representation 420. The model may be applied or queries may be executed to identify the matched group of subjects of common representation 440, which are then used as input to the analytics to be applied to raw data 445. Once the analytics are applied to raw data 445, the output is provided to the first party 410 (i.e., the consumer) as a final output.

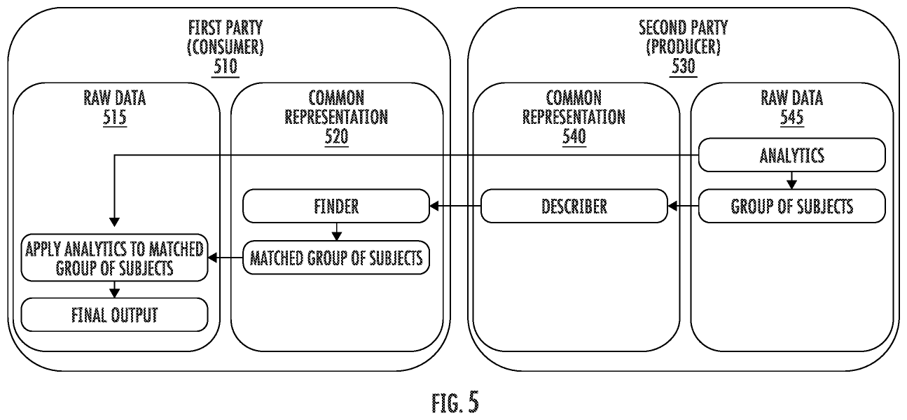

FIG. 5 illustrates an exemplary configuration where the first party 510 (i.e., the consumer) desires to utilize analytics from data sets of at least one other party's data (i.e., second party 530) to aid in grouping the data of the first party. In this configuration analytics and/or a group of subjects may be defined within raw data 545 of the second party 530 (i.e. the producer). Using the common representation 540 of second party 530, the initial group of subjects in raw data 545 is provided as input to the describer, which then trains a model or defines a set of queries to recognize those subjects as distinct from all other subjects.

Using common representation 520 of first party 510 (i.e., the consumer), the finder may apply the model or execute the queries provided by the describer of the common representation 540. The model may be applied or queries may be executed to identify the matched group of subjects of common representation 520 and output the analytics to apply to raw data 515. Once the analytics are applied to raw data 515, the output is provided to the first party 510 as a final output.

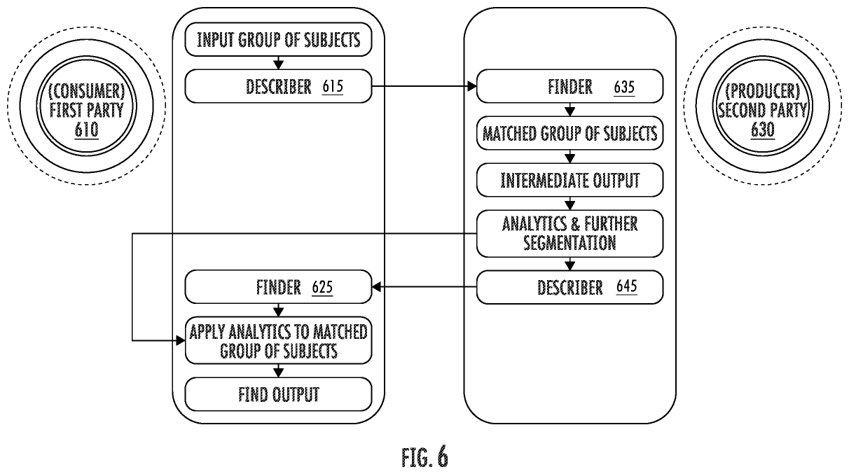

FIG. 6 illustrates an exemplary configuration combining the configurations of FIG. 4 and FIG. 5. First party 610 (i.e., the consumer) uses an input of a group of subjects which are modelled in a describer 615 via a common representation. The trained describer 615 may be provided to the finder 635 of second party 630 (i.e., the producer). Finder 635 may match a group of subjects in second party's data and provide an intermediate output. Using analytics and further segmentation on second party's 630 data, a subsequent describer 645 model may be determined by second party 630. This model may be passed to the finder 625 of first party 610 to further segment first party 610's initial group of input subjects. Once further segmented, analytics may be applied to the matched group of subjects to produce a final output of data for first party 610.

In an embodiment, data sets that are collected for different purposes and/or by different controllers may be kept separate. Analysis may be performed over the same group of individuals or individuals with similar behaviors across the different data sets. Individuals may not be matched deterministically across data sets due to legal/regulatory restrictions (e.g., GDPR). The present system and method may be used to generate a non-deterministic matched grouping across disparate data sets, allowing for matched segment/group level analytics to be performed.

In an embodiment, data sets that were collected for different purposes and/or by different controllers may be retained in their original location within each controller's environment. Analysis may be performed over the same group of individuals or individuals with similar behaviors across the different data sets by generating a describer in situ from one data set, and applying the resulting finder to one or more other data sets without transferring any actual data out of the original locations. Because both the features and target groups/segments built over the consumer's data set to construct the describer are k-anonymous, the present system and method may be used to apply analytical insights to one or more producer data sets without compromising on the privacy rights of the consumer's data subjects, or violating their trust.

In an embodiment, data sets are desired to be merged or joined, but deterministic matching may not be performed due to legal/regulatory restrictions (e.g., GDPR). The present system and method may be used to probabilistically associate groups/segments identified on each data set, allowing for segment-level analysis to be performed.

In an embodiment, where appropriate consent and lawful basis for disparate data sets to be merged or joined exists, but deterministic matching cannot be performed due to the lack of a common key across the data sets, the present system and method may be used to generate the required common key at a grouped segment level.

In an embodiment, where appropriate consent and lawful basis for disparate data sets to be merged or joined does not exist, the data sets may be joined on a common key that corresponds to a minimum number of data subjects. The present system and method may be used to generate the required common key at a grouped segment level with the required privacy characteristics in the form of minimum numbers of associated records and/or data subjects.

In an embodiment, disparate data sets may take the form of consented and non-consented data. The present system and method may be used to perform privacy-preserving analytics across combined consented and non-consented data sets, ensuring k-level anonymity for the individuals contained therein. Where non-consented data sets are involved, if there is no lawful basis under local data protection regulations, more advanced additional techniques may need to be applied, such as full anonymization of the non-consented data.

In an embodiment, each party set may act simultaneously as the consumer and the producer for combined analytics to be performed, with multiple common representations and describers possibly generated from a data set to support different analytical use cases, and multiple finders generated from other data sets possibly applied to generated combined analytical outputs.

In an embodiment, data controllers may make common representation descriptions and describer models available for use by any number of other data controllers to overlay insights upon their data and perform combined analytics via a two-sided marketplace.

In an embodiment, where data controllers participate in a two-sided marketplace to produce and/or consume analytical insights from other data sets, self-service capabilities are offered to allow analysts at data controllers to create new common representations, describer models and analytical outputs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for providing the ability to analyze disparate data sets via the use of either individual to segment or segment to segment matching using modelling or querying approaches, the method comprising:
creating a common representation across all consumer and producer data sets;
training one or more models or defining one or more queries optimized to recognize the behavior of the specified subjects within the generated common representation;
identifying likely candidates for the specified subjects in the common representation of each producer data set using the one or more trained models or the one or more queries;
performing analytics over the identified subjects for each producer data set; and
output the analytics result.

2. The method of claim 1, wherein the creating a common representation includes evaluating an input list.

3. The method of claim 1, wherein the creating a common representation includes creating a detailed feature array.

4. The method of claim 1, wherein the creating a common representation includes forming geo-spatial features.

5. The method of claim 1, wherein the creating a common representation includes forming temporal features.

6. The method of claim 1, wherein the creating a common representation includes forming features based on spending behaviors.

7. The method of claim 1, wherein the creating a common representation includes forming features based on product/band affinities.

8. The method of claim 1, wherein the creating a common representation includes forming features based on demographics or other data subject characteristics common to both data sets.

9. The method of claim 1, wherein the creating a common representation includes data provided by a third party.

10. The method of claim 1, wherein the performing includes creating a detailed feature array or common representation.

11. The method of claim 1, wherein the performing includes evaluating a model.

12. The method of claim 1, wherein the performing includes executing queries.

13. The method of claim 1, wherein the performing includes compiling vectors.

14. The method of claim 1, wherein the performing includes sorting and grouping the array.

15. The method of claim 1, wherein the performing includes performing analytics.

16. The method of claim 1, wherein the training occurs via a sub-system for compiling a description of data relating to a group of entities.

17. The method of claim 1, wherein the performing occurs via a sub-system for assessing the data of each entity against the compiled description.

18. The method of claim 1, wherein a two-sided marketplace enables data controllers to provide data sets for analysis and consume insights produced from other data sets in a privacy-enhanced way.

19. The method of claim 1, wherein self-service capabilities are provided to enable data controllers to create common representations, describer functionality and analytics.

20. A system for providing the ability to use k-anonymous groups to analyze disparate data sets via the use of either individual to segment or segment to segment matching using modelling or querying approaches, the system comprising:
a sub-system that creates a common representation across all consumer and producer data sets;
a describer sub-system that includes training one or more models or defining one or more queries optimized to recognize the behavior of the specified subjects within the generated common representation;
a finder sub-system that highlights likely candidates for the specified subjects in the common representation of each producer data set using the one or more trained models and/or the one or more queries;
the describer and finder sub-system performing actions over the identified subjects for each producer data set; and
output to output the analytics result.

21. The system of claim 20, wherein the sib-system that creates a common representation performs by at least one of evaluating an input list, creating a detailed feature array, forming geo-spatial features, forming temporal features, forming features based on spending behaviors, forming features based on product/band affinities, and forming features based on demographics or other data subject characteristics common to both data sets.
